(19) United States
(12) Patent Application Publication
(10) Pub. No.: US 2020/0193458 A1
(43) Pub. Date: Jun. 18, 2020

(54) A WEB-BASED METHOD FOR ENHANCED ANALYSIS OF ANALYTICS SETUP AND DATA

(71) Applicant: SPARKLINE PTE. LTD., Singapore (SG)

(72) Inventor: Vinoaj VIJEYAKUMAAR, Singapore (SG)

(73) Assignee: SPARKLINE PTE. LTD., Singapore (SG)

(21) Appl. No.: 16/323,288

(22) PCT Filed: Jul. 19, 2017
(86) PCT No.: PCT/SG2017/050363

§ 371 Date: Feb. 5, 2019

(30) Foreign Application Priority Data
Aug. 5, 2016 (SG) 10201606517P

(51) Int. Cl. G06Q 30/02

(52) U.S. Cl. CPC G06Q 30/0201

(57) ABSTRACT

An automated method for assessing a website or application, including obtaining function data relating to the functions and options selected by the user of the website or application; accessing analytics data relating to the website or application; accessing the website data including HTML data; analyzing the analytics data, web site data and function data, using a set of heuristics assessing predetermined analysis points in order to audit the operation of the website or application and determine the performance of the website or application in relation to predetermined parameters relating to each analysis point; providing an audit score and report, derived from the outcome of said heuristic, including a prioritized identification of issues requiring rectification; and providing instructions on how to rectify the issues identified.

### FIELD OF THE INVENTION

The present invention relates to a process and product for providing enhanced analysis of the implementation of analytics for websites and applications, the users of those websites and applications, and the activity of users within and performance of those websites and applications.

### BACKGROUND OF THE INVENTION

Websites and applications have now become important media for promoting products and services, no matter the size or function of the business. They have brought marketing and promotional opportunities. Many businesses today have their own dedicated websites and applications. These help to improve customer engagement, create a direct marketing channel and brand awareness for the business. Measurement of such digital assets are therefore critical for the business to succeed in their online strategies.

Web and application based advertising campaigning is extremely common. For some commercial organisations, a web or application based campaign is the primary source of their revenue. A web-based campaign can be utilized for directing potential customers to websites or applications and to promote products and services. A visitor lands on a user's website or application by clicking on the link to the campaign published by the user on any other website or webpage. This may be via social media or other services such as Facebook™, TripAdvisor™, or Twitter™. It may be accessed or identified using a search engine such as Yahoo™, Bing™, or Google™, either as a regular search result or via a paid advertising service such as Google AdWords™.

Given the importance of this advertising channel for many organisations, it is very important to know the behaviour of the visitors, how they use the website, and to understand who the visitors are and how they access the website.

Such organisations are the main users of web-based analytics platforms such as Google Analytics™ (hereinafter GA), Google Analytics 360™ (hereinafter GA360), and Adobe Analytics™ (hereinafter AA). These web analytics services help organisations to keep track of visitors and to record the details of traffic on the user's website or application. It is very crucial for these web analytic programs to assess a large data set to provide meaningful business insights. GA, GA360 and AA have various analytics features and tools to help their users in assessing this data set and create an analytical report about visitor's behaviour and the performance of their site or application. The report may indicate, for example: at what time of the day visitors were active; what are the popular browsers among the visitors; what pages have been viewed and the duration of the viewing, who is purchasing which products, and many other such parameters. It will be appreciated that while GA, GA360 and AA are references as they are widely used, the following discussion is equally applicable to other analytics systems.

It is often unclear whether analytics systems are set up correctly to measure a website or application. A comprehensive setup is dependent on the experience, expertise, and competency of the parties involved in implementing the analytics solution. Often stakeholders are unaware how complete or accurate the implementation is.

An interactive audit tool is therefore required to take the raw output from the analytics system, and generate a report for an organisation, which is customised to the website/application, business needs and revenue model of that organisation.

### DISCUSSION OF THE PRIOR ART

Currently, various types of online tools are available to audit the tracking data and the traffic records derived from GA, GA360 or AA, such as Check My Analytics, Little Data, Mixed Analytic, LunaMetrics, Northcutt, Annielytics, Boxcar Marketing, Optimize Smart, Dragon Search and New City. These online tools connect via a respective Application Programming Interface (API) to GA, GA360 or AA and collect the tracking data and traffic records in their database. These online tools run a limited number of tests on the collected data to generate an audit report which raises issues such as goal implementation, behaviour tests, and filter checks etc. These existing online tools target one analysis point at a time.

These existing tools require significant expertise from a consultant in order to be customised to and provide appropriate insights for an organisation. This represents a significant drawback, in that the requirement for extensive support from a human consultant adds significant costs to any implementation.

It is an object of the present invention to provide an audit service, process and software that provide a higher level of insights for the organisation while requiring less human intervention.

### SUMMARY OF THE INVENTION

In a broad form, the present invention provides an audit process which takes existing analytics data and uses a heuristic process to interact with the user and the analytics data to generate an audit report which comprises an audit score, a prioritized categorization of the issues identified and detailed instructions for implementation and recommendations for the user, covering both technical and non-technical aspects of their analytics set up (hereinafter referred to as an “implementation-instruction guide”).

According to one aspect, the present invention provides an automated method for assessing a website or application, comprising the steps of:

(a) Obtaining function data relating to the functions and options selected by the user of the website or application;
(b) Accessing analytics data relating to the website or application;
(c) Accessing the website data including HTML data;
(d) Analysing the analytics data, website data and function data, using a set of heuristics assessing predetermined analysis points in order to audit the operation of the website or application and determine the performance of the website or application in relation to predetermined parameters relating to each analysis point, wherein the number of analysis points is at least 20;
(e) Providing an audit score and report, derived from the outcome of said heuristic, including a prioritised identification of issues requiring rectification; and
(f) Providing instructions on how to rectify the issues identified.

According to another aspect, the method further includes providing, in response to the identified issues, an automatically generated, implementation-instruction guide which provides solutions for the issues identified, the guide being customised in response to the issues identified and the function data, the implementation-instruction guide enabling the user to implement the solutions and rectify their website or application without requiring a consultant.

According to another aspect, the number of analysis points is at least 25.

According to another aspect, the number of analysis points is at least 30.

According to another aspect, the number of analysis points is at least 35.

One aspect of implementations of the present invention is that the tracking data and traffic records are retrieved from the analytics system used, for example GA, GA360 or AA API, as well as from accessing and inspecting the HTML code of the website or application.

This embodiment of the present invention comprises an audit tool and an implementation tool. The audit tool runs a heuristic targeting a multitude of desired analysis points on the analytic data retrieved from all the various sources and generates an audit report.

The audit report according to this implementation comprises:

(A) an automatically generated audit score based on the assessment of such analytics data for the multitude of analysis points;
(B) a prioritized categorisation of the issues identified, based on the assessment of such analytics data for the multitude of analysis points, such prioritized categories including:
(i) “warnings” which refer to issues that are advised to be dealt with expeditiously;
(ii) “high priority issues” which are issues advised to be dealt with as a matter of high priority;
(iii) “medium priority issues” which may be dealt with in due course;
(iv) “low priority issues” that the user may choose to deal with as convenient to the user. and
(C) a set of customised detailed recommendations and instructions for implementation (hereinafter called the “implementation-instruction guide”) for the user, covering both technical and non-technical aspects of the analytics set up of the user's website or application.

The implementation-instruction guide provides solutions to the issues identified in the audit report and enables the user to implement the solutions to the analytics set up of their website or application on their own without the need to appoint a human consultant.

The audit tool also allows the user to schedule future audits of their analytics setup in accordance with the user's preference. The audit tool also allows the user to store the audit report in an archive so that it can be subsequently accessed.

### BRIEF DESCRIPTION OF THE DRAWINGS

An illustrative embodiment of the invention will now be described by reference to the accompanying drawings, in which:

FIG. 1: is a flowchart for assessing an analytic data.

FIG. 2: is a flowchart for tracking Ecommerce process flow.

FIG. 3: is a flowchart for checking Google AdWords™ data cleanliness.

FIG. 4: is a flowchart for checking Google AdWords™ linkage.

FIG. 5: is a flowchart for checking Display Advertising Support.

FIG. 6: is a flowchart for checking Filters.

FIG. 7: is a flowchart for checking Non-AdWords Campaign.

FIG. 8: is a flowchart for checking Goal Coverage Test.

FIG. 9: is a flowchart for checking Default Page Settings.

FIG. 10: is a flowchart for tracking Events.

FIG. 11: is a flowchart for checking URL Query Parameters.

FIG. 12: is a flowchart for checking Bot filters.

FIG. 13: is a flowchart for checking User Permissions.

FIG. 14: is a flowchart for defining Custom Dimensions and Metrics.

FIG. 15: is a flowchart for checking Industry Category Setting.

FIG. 16: is a flowchart for checking Self-Referrals.

FIG. 17: is a flowchart for checking Traffic Sources.

FIG. 18: is a flowchart for checking Time Zone settings.

FIG. 19: is a flowchart for checking 404 Pages.

FIG. 20: is a flowchart for checking Crash and Exception Process Flow.

FIG. 21: is a flowchart for assessing DoubleClick Campaign Manager™ Integration.

FIG. 22: is a flowchart for Remarketing List Process Flow.

FIG. 23: is a flowchart for checking Screen Names.

FIG. 24: is a flowchart for checking Spam Traffic.

### DETAILED DESCRIPTION OF THE PREFERRED EMBODIMENTS

### Terms Used in the Specification

The following definitions are intended to be used throughout the specification and claims.

404 Pages: The 404 is the Hypertext Transfer Protocol's standard response code that is triggered when the user tries to communicate with a server and that server is not able to find the requested resource. In that eventuality, the web site hosting server generates a “404 NOT FOUND” web page.

Analytics: This term is intended to mean the data and reports produced by services such as GA, GA360 and AA, but is not limited to these products. The analytics may be generated by any suitable system, currently known or yet to be developed, for use in the implementations of the inventive system. Further, the nature of the data and reports from such systems may be expected to change over time, with concomitant changes to the implementation details.

Behaviour Analysis: GA, GA360 or AA allows users to keep track of the visitor's behaviour on their website or application. Such behaviour tracked includes information thereof such as the pages which are popular among visitors, and the pages which are skipped over by the visitor. GA Shopping Behaviour Analysis allows the user to record how many steps the visitors tended to skip over in a session or at what step of the GA goal funnel the visitor abandons the user's website. GA Shopping Behaviour Analysis allows the user to see how successfully their visitors move through their checkout process.

Conversion Rate: Conversions are desired behaviour on a website or application—e.g. completion of a purchase, signing up for a newsletter, etc. The conversion rate is calculated as the number of conversions divided by the total number of sessions.

Cost per Click (CPC): This term to a paid campaign wherein the advertiser makes payment to the publisher based on the number of clicks from visitors during the contracted period. The publisher is typically a website or application owner who publishes the user's campaign on his website, webpage or application. For this the user has to set a value for the CPC in their advertising platform (e.g. Google AdWords™).

Crash and Exception Measurement: Crash and exception measurement refers to the measurement of the number and type of caught and uncaught crashes and exceptions that occur in the user's website or application. The required fields are “description” and “isFatal” where the “Description” provides the details of the crash and exception reporting and “isFatal” indicates whether the exception is fatal for the user's application. GA, AA and GA360 allow the user to keep track of such data.

Custom Dimensions and Metrics: This term refers to the function permitted by GA, GA360 or AA where the user is permitted to create the custom dimensions and custom metrics for collecting and analysing the data that GA, GA360 or AA do not automatically track.

DoubleClick Search (DS): This term refers to an analytics feature provided under the premium services of GA, GA360 or AA where the user is able to use the DoubleClick Search reports to see which keywords, dynamic targets, and other biddable items lead to GA, GA360 or AA transactions and goals, including session goals. It will also allow the user to create a bid strategy to maximize the transactions and action-based conversions of their website.

Ecommerce: Ecommerce or electronic commerce refers to the selling and buying of products and services over the Internet. If the user is selling any goods or services online, he should enable GA, GA360 or AA ecommerce tracking functionality details and attribution.

Enhanced Ecommerce: Enhanced Ecommerce is a feature of GA that allows the user to check the state of their business and provides four metrics for assessment by the user: (1) Revenue: i.e. the total revenue from the ecommerce transaction, (2) Ecommerce Conversion Rate i.e. number of transactions divided by the total number of sessions, (3) Transactions: the total number of ecommerce transactions completed by a visitor on the user's website or application, the average value for each order and the average quantity of products sold per transaction, (4) Marketing: the revenue and the order value generated by the user's internal promotion.

Events: An Event is an action or a class of actions performed by the visitor on the user's website or application. Event tracking allows users to track the visitor's interaction with the elements of the user's campaign on the website or application for example: navigating through a photo album, clicking a link on the user's website, scrolling to the depth of the webpage, clicking on social share buttons. The user should enable GA, GA360 or AA event tracking functionality details and attribution.

Filters: Filters are features available in GA, GA360 or AA. The filters are applied to the user's GA view, GA360 view or AA view to influence the type of data that appears in the analytic data sent to the user. For example: the user may include only a specific subset of visitor's traffic, he may exclude the spam traffic or he may search for certain pieces of the information only. Incorrect or suboptimal setting of filters in GA view, GA360 view or AA view can distort the analytic data produced. This will affect how meaningful the analytic data is to the user.

Google AdWords™: It is a website and application based advertising service provided by Google that allows users to display a copy of the campaign (“campaign copy”) on a publisher website or application. The campaign copy directs the visitors to the content of the users' website or application, when the campaign copy is clicked on. The user makes payment to the publisher when the visitors are diverted to the user's website, webpage, or application upon clicking on the displayed campaign copy, and the publisher websites or applications will receive a portion of the revenue generate by the users campaign attributable to clicks on the displayed campaign copy.

Google AdWords™ remarketing: Google AdWords™ remarketing is a form of online advertising that enables the users to show their campaign to the visitors who have already visited the user's website or application while browsing the web.

Goal Coverage: The GA goal coverage feature permits the users to assess the effectiveness of their campaigns. The goals are the values set by the user for his website or application. GA goal tracking feature allows the user to check exactly how many visitors visited his campaign. If the user has not set up the goals, he cannot:

a) Measure Conversion Rate (i.e. desired events) on the website or application
b) Conduct Revenue analysis to evaluate the effectiveness of the online marketing campaigns.
c) Make use of Goal funnels and attribution modelling reports.

Organic traffic: The visitor who comes to the user's website or application using an organic search engine and clicking on an organic search result. Examples of organic search engines are Google™ or Bing™.

Orphaned Filters: These are filters that are defined by the user but not applied to any of their analytics reports.

Regular Expressions: The Regular Expression is used here in context of GA where GA allows the user to create his own regular expressions using the data or information to be matched for the better implementation of GA event goals, GA filters etc. For example: if the user wishes to capture the traffic from a particular URL or IP then he may include that URL or IP address as a variable in the regular expression in either the GA filters or GA event settings.

Screen Name Tracking: GA screen name tracking feature enables users to track the visitors on their application. This feature allows the user to measure the number of screen views by visitors, for tracking the content most viewed by visitors or the behaviour of the visitor while navigating between different pieces of content of the website or application.

Self-Referrals: A referral occurs when the visitor diverts from some other source or website to the user's website or campaign. This referral is recorded in a referral report that the user may use in the assessment of the visitor's conversion rate or revenue generation. A self-referral refers to the situation where the traffic is derived from the user's own domain or subdomain. This would indicate that the user has a configuration issue or has missed a tracking code in their website.

Traffic Sources Report: GA, GA360 or AA the traffic sources reports record the different sources that are sending the traffic to the user's campaign or website or application, for example: paid traffic, traffic from search engine, spam traffic, self-referral traffic.

Transaction ID: GA, GA360 or AA assigns a unique transaction ID to each visitor involved in the transaction in the user's website or application.

User: In the present invention, the user is the commercial organisation that has been configured to GA, GA360 or AA or other web analytic systems to which this invention applies.

UTM parameters: These are the tracking tags added in the URL to identify the source of the click. When the visitor clicks on the user's link, the tracking tags are sent to GA, GA360 or AA to evaluate the effectiveness of the campaign.

Visitor: In the present invention, a visitor is a person or an automated computer program that is generating events or traffic on the user's website or application within a defined time period.

It will be appreciated that the detailed embodiment described below represents one specific implementation, and that the present invention is not limited in scope to this specific implementation, to any particular analytics data, or to any particular interface. Various features, for example specific analysis points, may be omitted or substituted in different implementations, and additional features and components may be added.

For the purposes of the examples provided herein, GA is used only as an example illustrating the working of the present invention. This present invention is equally applicable to other analytics systems, known or yet to be developed.

The present invention is envisaged as being implemented as a server, real or virtual, accessible to users via the Internet. Thus, each user provides access to their analytics data, which is then analysed and processed automatically in the remote server.

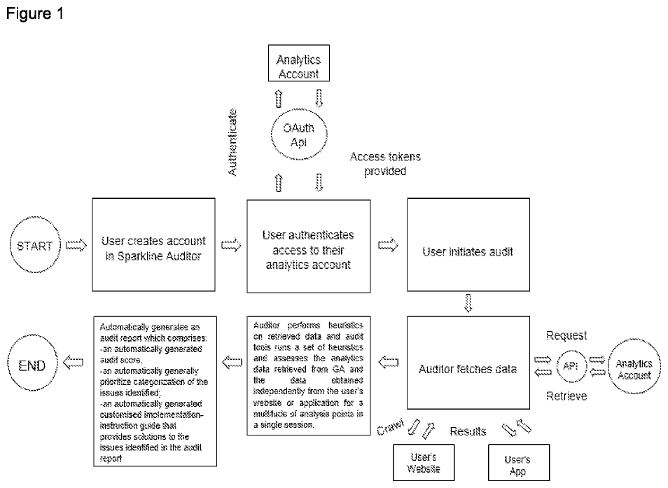

FIG. 1 describes how, in an implementation of the present invention, the user creates an account in an audit tool. The user initiates an audit after authenticating access to their analytics account via an authentication API. The audit tool extracts the user's analytics data from their analytics account via API. The audit tool also obtains data independently from crawling the user's website or application.

Then the audit tool runs a set of heuristics and assesses the analytics data retrieved from GA and the data obtained independently from the user's website or application for a multitude of analysis points in a single session and then automatically generates an audit report which comprises:
an automatically generated audit score;
an automatically generated prioritized categorization of the issues identified and;
an automatically generated customised implementation-instruction guide that provides solutions to the issues identified in the audit report;

It is important to understand that selection of analysis points, and the nature of the analysis, will be influenced by the user's website or application. For example:
If the user provides search functionality on their website, the audit tool will check if GA is set up to track usage of the website's search functionality.
If the user's website/application has ecommerce functionality, the audit tool will check if ecommerce tracking is set up correctly in the website/application.
If the user runs an online advertising campaign, the audit tool will check for different scenarios depending on the user's answers. For example, if AdWords is used, the heuristic will check for AdWords account linkage & AdWords data cleanliness; if DoubleClick is used, the heuristic will check for DoubleClick accounts linkage.

Thus, the report produced is customised by the user's selections, or function data about the website, as this influences the analysis points and the parameters checked. The report is further customised by reporting against the large set of analysis points, and with the issues prioritised for attention.

It is preferred that the number of analysis points is at least 20, more preferably at least 35 analysis points. In a preferred implementation, the analysis points may comprise at least the following:

E-commerce tracking, Google AdWords™ Account Linkage, Advertising Features, Filters, Non-AdWords Campaign, Goal Coverage Test, Default Page Setting, Events, URL Query Parameters, BOT Filtering, User Permission, Custom Dimensions and Metric, Industry Category Setting, Self-Referrals, Traffic Sources, TimeZone Settings, Google AdWords™ Data Cleanliness, 404 Pages, Crash and Exceptions, Remarketing Lists, Screen Names, Spam Traffic, AdSense Linkage, Attribution Model, DoubleClick Bid Manager Integration, DoubleClick Campaign Manager Integration, DoubleClick Search Integration, Google Ad Exchange™ Linking, Google Analytics Tracking Code™, Google BigQuery™ Linking, Page URL Consistency, Property Settings, Property Type, Site Search Tracking and Within Hit Limits.

Of course, it will be appreciated that in principle a larger number of points will enable richer and more particular analysis, and hence insights, to be obtained. Thus, larger numbers of analysis points, or different analysis points, may be used in other implementations of the present invention.

Examples of the 35 analysis points are discussed below in detail.

### Example 1

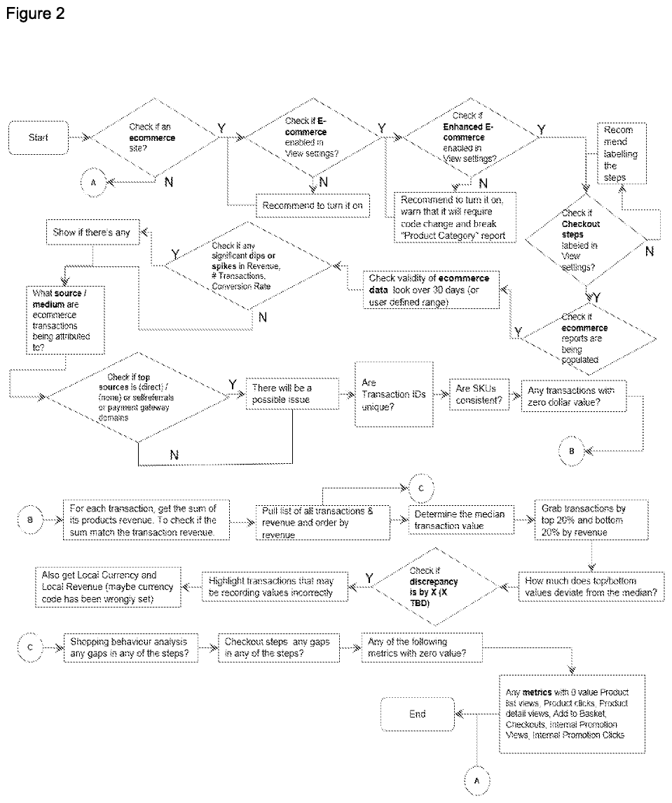

FIG. 2 describes the ecommerce process flow tracking. The heuristic first checks whether the user's website is an ecommerce website and proceeds to apply a heuristic on the website only if the user's website is the ecommerce website. The steps involved in tracking the ecommerce process flow are:

| | |
|---|---|
| STEP 1. | The heuristic checks whether GA ecommerce tracking |
| | is enabled in the user's website or application. |
| | If GA ecommerce is not enabled then the heuristic |
| | will generate a warning “to turn GA ecommerce ON” |
| | in the Audit report and instructions on how to |
| | implement ecommerce tracking. |
| STEP 2. | The heuristic checks whether GA enhanced ecommerce |
| | is enabled in the GA view for the user website or |
| | application. If GA enhanced ecommerce is not |
| | enabled, the heuristic will generate a warning |
| | “to turn GA enhanced ecommerce ON” and that “it |
| | will require code change and break Product |
| | category report” in the Audit report. The |
| | heuristic will also generate instructions on |
| | how to implement enhanced ecommerce tracking. |
| STEP 3. | The heuristic checks whether the checkout steps |
| | are created and recorded properly in the GA view |
| | for the user website or application. If the labels |
| | are not properly labelled then the heuristic will |
| | generate a recommendation to label the steps in |
| | the user's website or application in the Audit |
| | report and generate instructions on how to |
| | implement checkout step tracking. |
| STEP 4. | The heuristic checks for the transactional data |
| | in the user's website or application by reviewing |
| | the GA ecommerce reports. In the present invention |
| | the heuristic checks for the transactional data |
| | for over 30 days (or the time period defined by |
| | the user in the GA view). |
| STEP 5. | The heuristic checks for significant dips or spikes |
| | in revenue of the user's e-commerce website or |
| | application, currency transactions in the user's |
| | website or application and conversion rate of the |
| | visitors in the user's website or application. The |
| | heuristic will update the Audit report for the |
| | revenue data, conversion data. |
| STEP 6. | The heuristic checks for the type of traffic |
| | sources for the ecommerce transactions in the |
| | user's website or application i.e. whether the |
| | traffic source is CPC, organic, referrals or self- |
| | referrals. The heuristic will generate instructions |
| | on how to exclude payment gateways from referrals, |
| | and also on how to exclude self-referrals. |
| STEP 7. | The heuristic checks GA SKU to check if SKUs are |
| | consistent and to evaluate the transactions with |
| | zero dollar values. The heuristic will generate |
| | recommendation on maintaining a unique SKU per |
| | product and instructions on how to ensure correct |
| | implementation of enhanced ecommerce transaction |
| | tracking. |
| STEP 8. | The heuristic sums up the user's product revenue |
| | data taken from GA for each transaction and checks |
| | if this sum matches the user's total transaction |
| | revenue in the analytic data. The heuristic will |
| | generate instructions on how to ensure correct |
| | implementation of enhanced ecommerce transaction |
| | tracking. |
| STEP 9. | The heuristic pulls out the list of all |
| | transactional data based on the revenue to check |
| | the shopping behaviour of the visitor and also |
| | checks for the gaps in the visitor's behavior |
| | while visiting the user's ecommerce website or |
| | application. The heuristic will generate |
| | instructions on how to implement shopping |
| | behaviour step tracking. |
| STEP 10. | The heuristic checks for the transactions |
| | recorded incorrectly, the metrics with zero value, |
| | the products mostly viewed by the visitors, the |
| | products mostly clicked by the visitors, the |
| | products viewed in detail by the visitors, the |
| | products added to the basket, the number of |
| | successful and failed checkouts, the number of |
| | times the website or application promotions |
| | checked or clicked by the visitors. The heuristic |
| | will generate instructions on how to ensure correct |
| | implementation of enhanced ecommerce transaction |
| | tracking. |
| STEP 11. | The heuristic also checks for currency setting in |
| | the user's website or application and generates |
| | instructions on how to set correct currency display. |

### Example 2

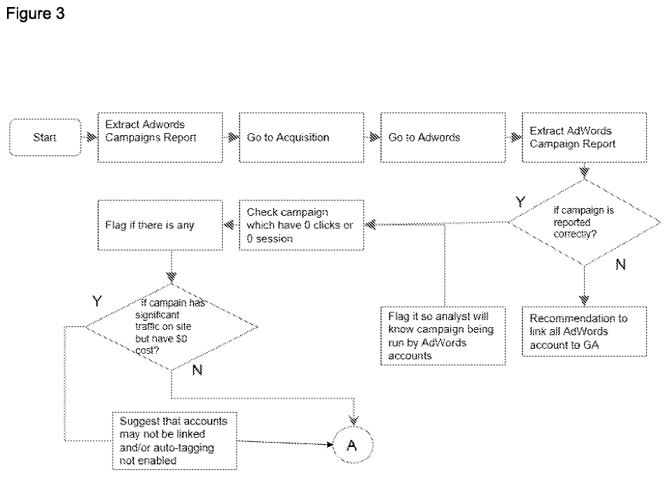

FIG. 3 describes the assessment of Google AdWords™ data cleanliness within GA. If the user is using Google AdWords™ to run their marketing campaigns, they should link their Google AdWords account to their GA account. This gives user access to the entire picture of visitors' behaviour, from ad-click to conversion (or non-conversion) i.e. how many visitors end up buying the user's product from the website. The heuristic utilizes the analytic data stored in GA and pulls out Google AdWords™ report. The heuristic checks for Google AdWords™ data cleanliness. The steps involved are:

| | |
|---|---|
| STEP 1. | The heuristic checks whether the campaign names |
| | with values have been setup correctly in the |
| | user's Google AdWords ™account. The heuristic will |
| | raise a warning and mark it as high priority issue |
| | if Google AdWords ™account has not been setup |
| | properly in the user's Google AdWords ™ account. The |
| | heuristic will generate instructions on how to link |
| | their Google AdWords ™ accounts to GA and how to |
| | enable auto-tagging in the user's Google AdWords ™ |
| | account. |
| STEP 2. | The heuristic checks for campaigns with zero number |
| | of clicks and reported campaigns with zero sessions. |
| | The heuristic will generate instructions on how to |
| | link their Google AdWords ™ accounts to GA and how |
| | to enable auto-tagging in the user's Google AdWords ™ |
| | account. |
| STEP 3. | The heuristic checks the traffic on the user's |
| | website or application and checks whether the |
| | landing page URLs for traffic coming from Google. |
| | The heuristic crawls that adding a GCLID URL parameter |
| | (GCLID: Google Click Identifier) and observes if a |
| | redirect happens, and if so, whether the GCLID |
| | parameter is retained. |
| | The heuristic will generate a recommendation for |
| | configuring redirects so that it retains the GCLID |
| | parameter and its value. |
| STEP 4. | The heuristic will extract Google AdWords ™ for the |
| | user's website or application and will update the |
| | Audit report for the user. |

### Example 3

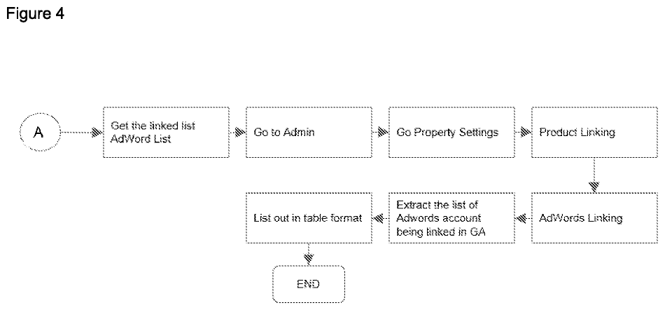

FIG. 4 describes the assessment of Google AdWords™ Account Linkage.

| | |
|---|---|
| STEP 1. | If the user has indicated that they run Google |
| | AdWords campaigns, the heuristic checks if any |
| | AdWords accounts are linked to the audited view. |
| | If there are no AdWords accounts linked, a |
| | recommendation will be provided with instructions |
| | on how to link their AdWords account. |
| STEP 2. | If there are Google AdWords accounts linked, the |
| | heuristic checks if there are unlinked accounts |
| | that are sending traffic to the user's website |
| | or application. It determines this by identifying |
| | any AdWords traffic that have zero cost or zero |
| | clicks associated with them. Recommendations will |
| | be provided on how to link the unlinked accounts. |

### Example 4

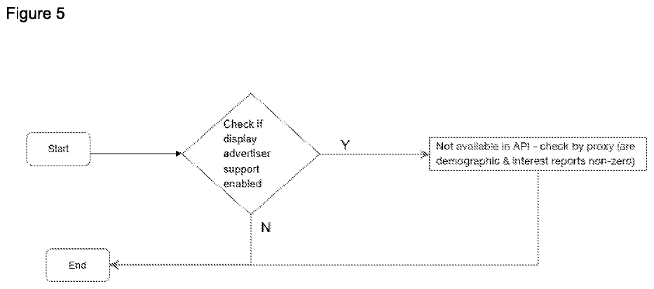

FIG. 5 describes the assessment of the Display Advertising Support is helpful to the user for the following reasons:
1. To generate demographics reports: it is helpful to understand the age and gender makeup of your users.
2. To generate Interests reports: understand what type of topics and products the users are interested in.
3. For remarketing: it can be created for visitors based on their website or application behaviour and remarket to them through Google AdWords™, DoubleClick Campaign Manager™, and/or DoubleClick Bid Manager®.

The heuristic checks for whether display advertiser support is enabled in the user's website or application. The heuristic extracts the age and gender and the visitor's area of interest data from the analytics data. The steps involved are:

| | |
|---|---|
| STEP 1. | The heuristic checks whether display advertising |
| | support is enabled in the user's website or |
| | application and checks if gender and interests |
| | dimension data is non-empty in the analytics data |
| | extracted from GA. |
| STEP 2. | The heuristic will update the Audit report for |
| | display advertising support and will generate a |
| | recommendation for the user to enable display |
| | advertising support in their GA account. |

### Example 5

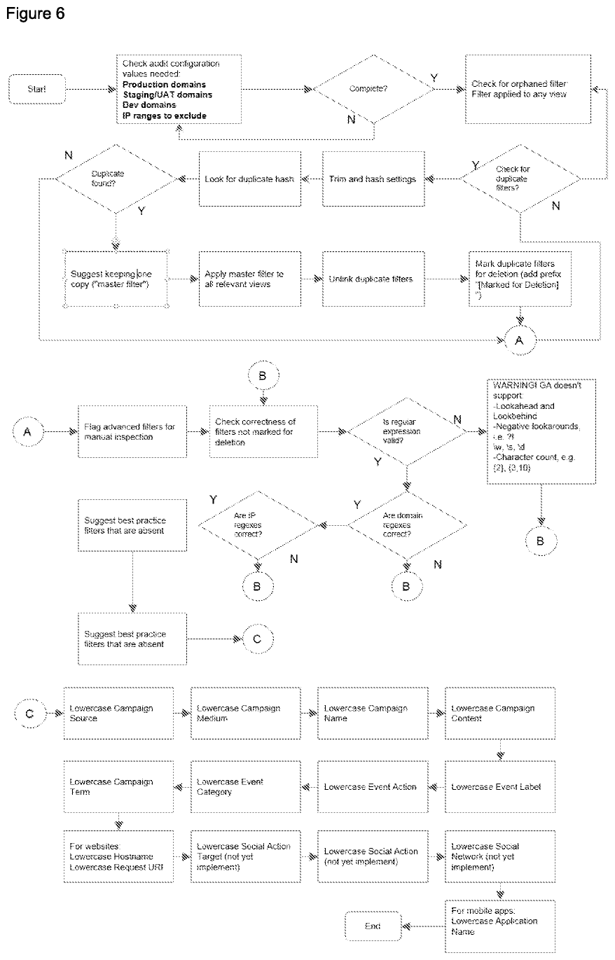

FIG. 6 describes the assessment of the filters in the user's website or application. The heuristic utilizes the analytic data and extracts a list of filters used in the user's website or application. The steps involved are:

| | |
|---|---|
| STEP 1. | The heuristic checks whether the user's website or |
| | application has enabled filters in their GA setup. |
| | The heuristic checks for “orphaned filters” and |
| | extracts a list of filters used in the user's |
| | website or application. The heuristic will |
| | generate a recommendation to disable “orphaned |
| | filters”. |
| STEP 2. | The heuristic checks for “duplicate filters”. The |
| | heuristic will generate a recommendation in the |
| | Audit report to keep only one “master filter”. |
| STEP 3. | The heuristic checks whether regular expressions |
| | are valid across all filters, are domain filter |
| | regexes correct and are IP regexes correct. For |
| | each regular expression the heuristic runs it |
| | against Python library Pattern.compile(x) to check |
| | validity. If a regular expression is invalid, the |
| | heuristic generates instruction on how to fix it. |
| STEP 4. | The heuristic will generate the best practice |
| | filters for the user's website or application. |
| | The heuristic will compare settings of filter on |
| | the user's website or application against the |
| | list of best practice filters and identifies |
| | absence of any best practice filters. The |
| | heuristic will generate instructions for creating |
| | each best practice filters. |

### Example 6

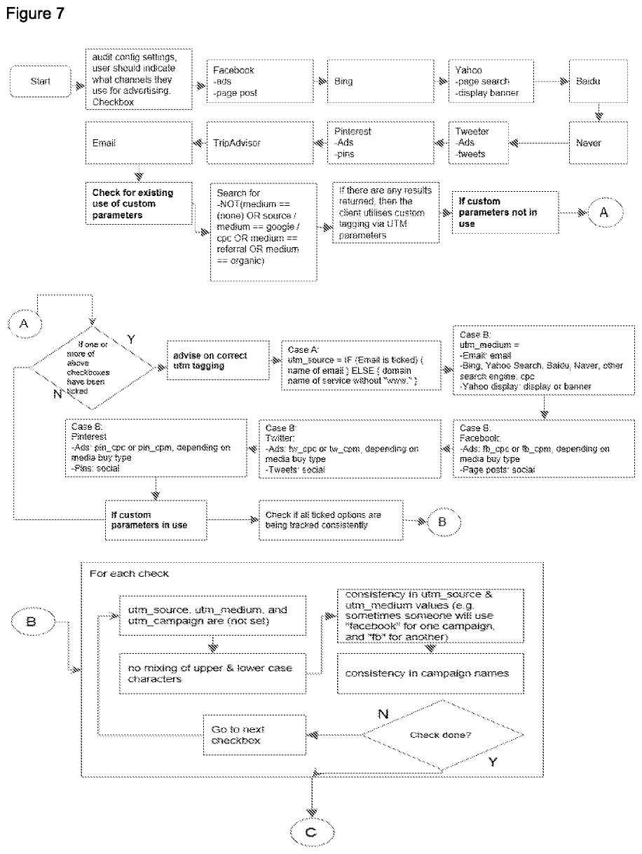

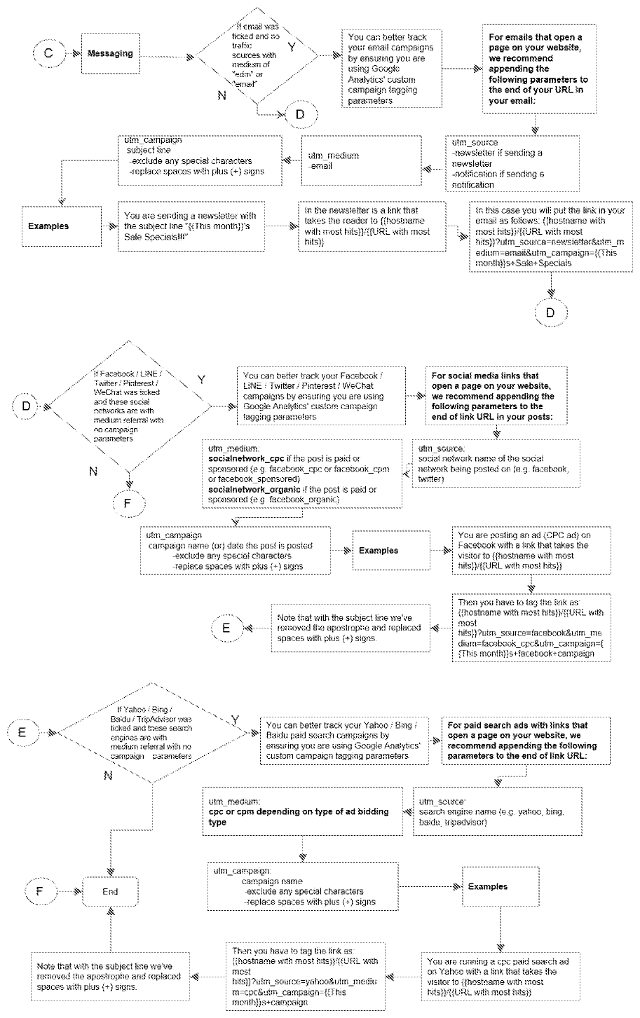

FIG. 7 describes the tracking non-AdWords paid campaign using GA. If the user's website or application is receiving traffic from sources such as Bing, Facebook, Baidu, Yahoo, Email, TripAdvisor, Pinterest, Twitter, Naver, then the user has to tag these campaigns for identifying and evaluating these campaigns as GA will treat visitors from these sources as organic and the attribution reporting of the user's website will be affected. The user can track their non-AdWords campaigns by ensuring that GA custom campaign parameters are used properly. The steps involved are:

| | |
|---|---|
| STEP 1. | The user has to define the advertising channels |
| | used by them in the GA view by ticking the |
| | appropriate checkboxes. |
| STEP 2. | The heuristic checks for existing use of GA |
| | custom parameters. |
| STEP 3. | The heuristic will search for campaigns that |
| | are not related to Google, CPC, Referral or |
| | Organic. |
| STEP 4. | If custom parameters are not in use then the |
| | heuristic will check if one or more of |
| | checkboxes has been ticked and will generate |
| | recommendation(s) for correct UTM tagging. |
| STEP 5. | The heuristic checks for UTM source. |
| STEP 6. | The heuristic checks for the UTM medium i.e. |
| | whether it is “Email” or “Bing, Yahoo Search, |
| | Baidu, Naver, other search engine”; |
| STEP 7. | The heuristic checks for: |
| | consistency for each UTM source; |
| | non mixing of lower and upper case character; |
| | consistency in UTM source and UTM medium. |
| STEP 8. | For “Messaging” non-AdWords: the heuristic |
| | checks if “email” has been ticked and whether |
| | there are any traffic sources with UTM medium: |
| | “edm” or “email”. The heuristic will generate |
| | the recommendation to use Google Analytics |
| | custom campaign tagging parameters. If there |
| | are emails that contain links that allow the |
| | opening of a page on user's website on clicking, |
| | a recommendation to append the following |
| | parameters to the end of the URL will be |
| | generated: |
| | For UTM source - newsletter (if sending a newsletter); |
| | notification (if sending notification) |
| | For UTM medium: email |
| | For UTM campaign: in subject line exclude special |
| | characters and exclude space with “+”. |
| STEP 9. | For Facebook, Line, Twitter, Pin interest, |
| | WeChat non-AdWords: for social media links that |
| | open a page to the user's website the heuristic |
| | will generate a recommendation to append the |
| | following parameters to the end of URL: |
| | For UTM source - social network name |
| | For UTM medium: is it cpc or organic (if post |
| | is paid or sponsored); |
| | For UTM campaign: in campaign name to exclude |
| | special characters and exclude space with“+” |
| STEP 10. | For Yahoo, Bing, TripAdvisor non-AdWords: for |
| | paid search ads that open page on user's |
| | website- the heuristic will generate a |
| | recommendation to append the following |
| | parameters to the end of URL: |
| | For UTM source - social network name |
| | For UTM medium: cpc or cost per mille (cpm) |
| | For UTM campaign: in campaign name to exclude |
| | special characters and exclude space with“+”. |
| STEP 11. | The heuristic checks if UTM parameters are in |
| | use and checks for existence of custom mediums - |
| | i.e. mediums that are not “(none)”, “organic”, |
| | “cpc”, or “referral”. The heuristic will |
| | generate instructions on how to use UTM |
| | parameters for non-AdWords campaigns with |
| | specific recommendations for email campaigns, |
| | Facebook, Twitter, etc. |
| STEP 12. | The heuristic checks whether UTM source, UTM |
| | medium, and UTM campaign are tagged on the user's |
| | website or application. The heuristic checks for |
| | custom sources & mediums, and no (not set) values |
| | for UTM sources, UTM mediums, and/or UTM campaigns. |
| | The heuristic will generate instructions on how to |
| | correctly use UTM parameters. |
| STEP 13. | The heuristic checks for mixing of upper & lower |
| | case characters in UTM values and processes data |
| | via API and check values are consistent. The |
| | heuristic will generate instructions on how to |
| | correctly use UTM parameters. |
| STEP 14. | The heuristic checks for consistency in campaign |
| | names and processes data via API and check values |
| | are consistent (particularly look at casing and |
| | spacing). The heuristic will generate instructions |
| | on how to correctly use UTM parameters. |
| STEP 15. | The heuristic checks for consistency in source |
| | names and processes data via API and check values |
| | are consistent (particularly look at casing and |
| | spacing). The heuristic will generate instructions |
| | on how to correctly use UTM parameters. |
| STEP 16. | The heuristic checks for consistency in medium |
| | names and processes data via API and check values |
| | are consistent (particularly look at casing and |
| | spacing). The heuristic will generate instructions |
| | on how to correctly use UTM parameters. |
| STEP 17. | The heuristic checks whether data import has been |
| | setup to import costs for non-AdWords campaigns and |
| | checks for existence of a cost data import bucket. |
| | The heuristic will generate instructions on how to |
| | correctly use UTM parameters. |

### Example 7

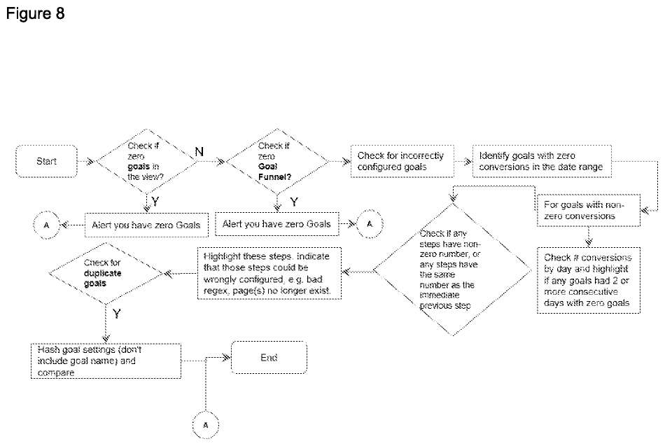

FIG. 8 describes the Goal Coverage Tests. The steps involved are:

| | |
|---|---|
| STEP 1. | The heuristic checks whether there are goals |
| | with the same number of completions and looks |
| | at conversions for each goal and identify if |
| | any sets of goals have identical conversion |
| | numbers. The heuristic will generate |
| | instructions for de-duping duplicate goals, |
| | and how to deactivate duplicate goals. |
| STEP 2. | The heuristic checks for goals with zero |
| | completion and look at conversions for each |
| | goal and identify goals with zero conversions. |
| | The heuristic will generate instructions on |
| | how to delete non-active goals. |
| STEP 3. | The heuristic checks whether there are |
| | destination-based goals with no funnels and |
| | looks at settings for each goal. Identify |
| | goals that are destination goals but do not |
| | have funnel steps associated with it. The |
| | heuristic will generate instructions on |
| | setting up funnels. |
| STEP 4. | The heuristic checks whether are there any |
| | goals that encountered a significant dip in |
| | numbers recently and looks at day-by-day |
| | conversions for each goal over the last 30 |
| | days. Highlight any goals where there was a |
| | significant dip in recorded numbers during |
| | that 30-day period. |
| STEP 5. | The heuristic checks whether funnels have |
| | been set up incorrectly. For each goal, the |
| | heuristic looks at session numbers for each |
| | step of the goal's funnel. Highlight any |
| | anomalous patterns (e.g. zero passthrough). |
| | The heuristic will generate instructions on |
| | how to fix any steps that are incorrectly |
| | configured. |
| STEP 6. | The heuristic checks for duplicate goals. |
| | The heuristic will generate instructions on |
| | how to removing the duplicate goals. |

### Example 8

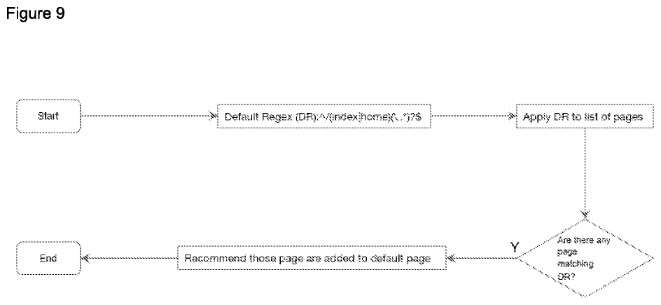

FIG. 9 describes the tracking default page setting. If the home page of the user's website can be accessed via several URLs (e.g. www.example.com/ and www.example.com/index.html) each URL will show up as a separate line item in the website page report even though it's for the same page. This makes assessing the performance of the web site home page difficult as the user will need to add up numbers across multiple lines in the website page report. The steps involved are:

| | |
|---|---|
| STEP 1. | The heuristic utilizes the analytic data and sets a |
| | regular expression such as “\hat{ }/(x\|y)(\ . . . *)?$”, |
| | where x and y can be either the index, home page, |
| | directory, about us page, etc |
| STEP 2. | The heuristic applies this regular expression on |
| | the each website page of the user |
| STEP 3. | The heuristic checks for whether there is any page |
| | that matches this regular expression. If yes, then |
| | it generates a recommendation for the pages to be |
| | added as default pages |

### Example 9

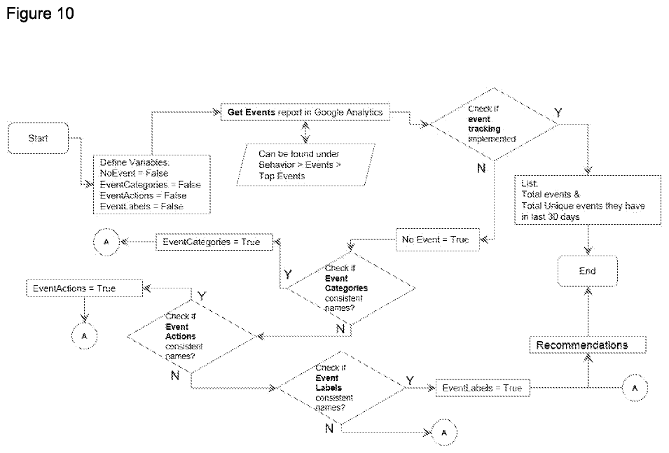

FIG. 10 describes the assessment of GA Events. The steps involved are:

| | |
|---|---|
| STEP 1. | The heuristic checks for undefined event |
| | categories or labels and looks at all event |
| | categories and labels and search for (not set) |
| | values. The heuristic will generate instructions |
| | on how to correctly set event category and action |
| | values. |
| STEP 2. | The heuristic checks whether event category, action |
| | and label values consistent. The heuristic extracts |
| | data via API and process values to ensure they are |
| | consistent (i.e. consistent spacing, casing, |
| | spelling). For highlight inconsistent values, the |
| | heuristic recommends to adopt a consistent naming |
| | convention. |
| STEP 3. | The heuristic checks for personally identifiable |
| | information that is being recorded in any event |
| | action, category, or label values. The heuristic |
| | looks at all values for event action, category |
| | and label dimensions and search for PII patterns |
| | (PII patterns such as email addresses). The |
| | heuristic provides guidance on stopping the |
| | recording of PII and/or applying filters to |
| | obfuscate PII. |
| STEP 4. | The heuristic checks for undefined event |
| | categories or labels and looks at all event |
| | categories and labels and search for (not set) |
| | values. The heuristic will generate instructions |
| | on how to correctly set event category and action |
| | values. |

### Example 10

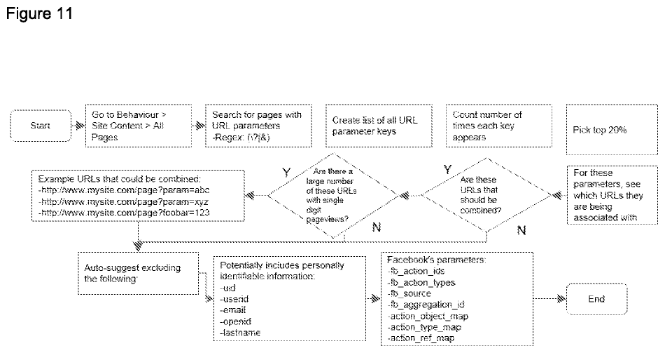

FIG. 11 describes the assessment of measurement of URL query parameters. The steps involved are:

| | |
|---|---|
| STEP 1. | The heuristic utilizes the analytics data and |
| | extracts recorded URL parameters. |
| STEP 2. | The heuristic checks for URLs having low |
| | clicks, URLs with single digit page views, |
| | or similar URL parameters. |
| STEP 3. | The heuristic lists out all URL query |
| | parameters, number of hits to each URL |
| | parameter, percentage of hits to each URL |
| | parameter, |
| STEP 4. | The heuristic generates recommendations to |
| | combine the URLs that are associated and a |
| | list of URLs that should be excluded, number |
| | of hits to each URL parameter, percentage |
| | of hits to each URL parameter |

### Example 11

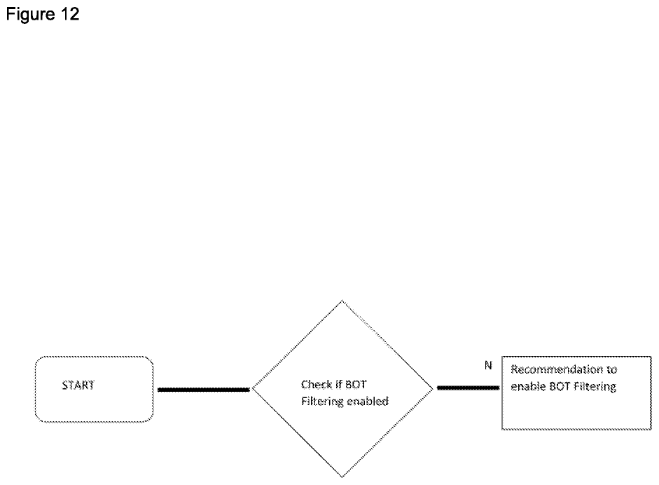

FIG. 12 describes the tracking bot using GA. The steps involved are:

| | |
|---|---|
| STEP 1. | The heuristic utilizes the analytics view |
| | settings and checks if “bot filtering” is |
| | enabled |
| STEP 2. | The heuristic generates the Audit report |
| | with a recommendation for the user to |
| | “enable” bot filtering and instructions |
| | on how to enable bot filtering. |

### Example 12

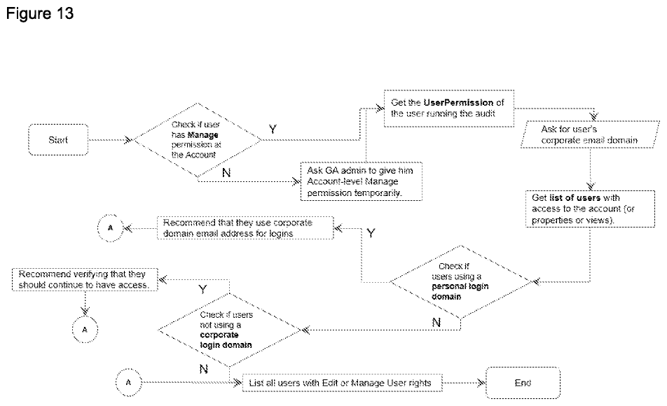

FIG. 13 describes the assessment of User permission in analytics setup of website or application i.e. to limit the number of users who can edit and manage the user's main account. It is best to limit the number of users within the commercial organisation. The steps involved:

| | |
|---|---|
| STEP 1. | The heuristic utilizes the analytics data and |
| | extracts the list of users with access to the |
| | users website account |
| STEP 2. | The heuristic checks if the user is using a |
| | personal login domain (e.g. @gmail.com, |
| | @yahoo.com, etc.), If yes then the heuristic |
| | will generate a recommendation to use the |
| | user's corporate domain and generates the |
| | Audit report listing all users with “EDIT” |
| | or “MANAGE” rights. If there are more than |
| | two users with “EDIT” or “MANAGE” rights, |
| | then the user is advised to limit the number |
| | of users with such privileges to their |
| | analytics account. |

### Example 13

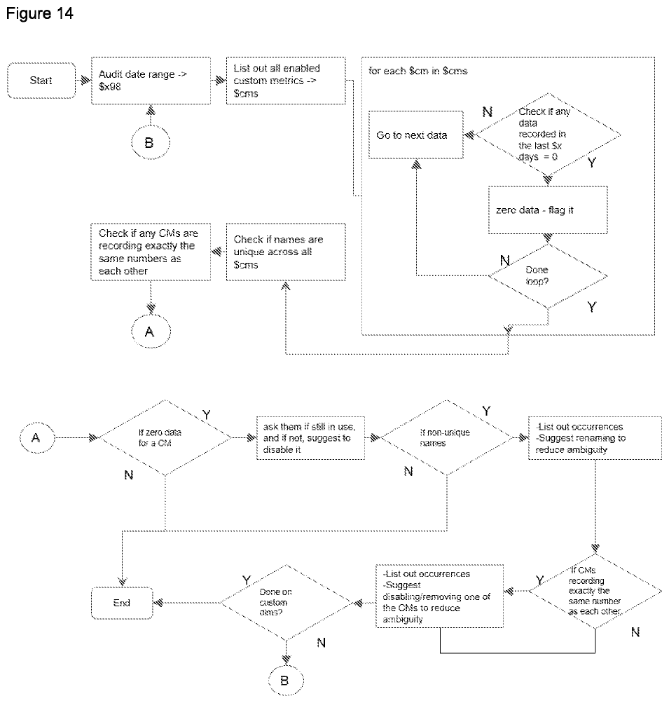

FIG. 14 describes the auditing of custom dimensions and metrics in GA. The steps involved are:

| | |
|---|---|
| STEP 1. | The heuristic checks whether any custom dimensions |
| | and metrics recording data and looks for hits for |
| | all custom dimensions and metrics. The heuristic |
| | searches for those with zero hits and generates |
| | instructions on how to disable unused custom |
| | dimensions and metrics. |
| STEP 2. | The heuristic checks if custom dimensions and |
| | metrics are uniquely named and identifies duplicates. |
| | The heuristic generates instructions on how to rename |
| | duplicate custom dimensions and metrics. |
| STEP 3. | The heuristic checks if any custom metrics recording |
| | exactly the same numbers. The heuristic looks at the |
| | number of hits for all custom dimensions and metrics |
| | and identify those with same number of hits and |
| | generates recommendation to disable one of duplicate |
| | custom metrics to reduce ambiguity. |
| STEP 4. | The heuristic checks if any custom metrics recording |
| | exactly the same values. The heuristic looks for hits |
| | for all custom dimensions and metrics and identify if |
| | there is duplication in data recorded and generates |
| | recommendation to disable one of duplicate custom |
| | metrics to reduce ambiguity. |
| STEP 5. | The heuristic checks whether personally identifiable |
| | information is being recorded and looks at all values |
| | for all custom dimensions and searches for PII |
| | patterns (PII patterns such as email addresses). |
| | The heuristic provides guidance on stopping the |
| | recording of PII and/or applying filters to obfuscate |
| | PII. |

### Example 14

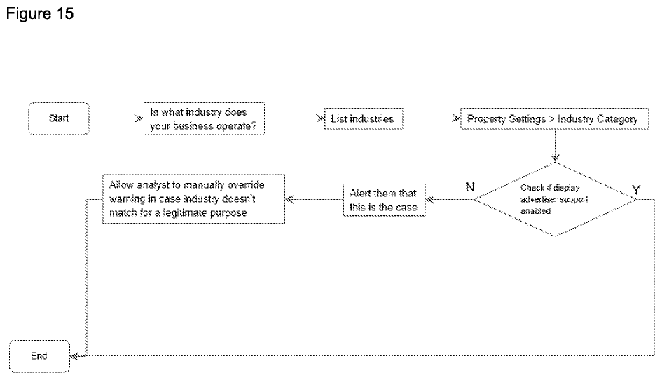

FIG. 15 describes the assessment of the industry category setting. The steps involved are:

| | |
|---|---|
| STEP 1. | The heuristic checks what industry the user's |
| | business operates in and checks if they have |
| | selected the right industry in their settings |
| STEP 2. | The heuristic will generate a warning if this |
| | is not enabled and will update the Audit Report |

### Example 15

FIG. 16 describes the assessment of Self-referral traffic in the user's website or application. The steps involved are:

| | |
|---|---|
| STEP 1. | The heuristic extracts the list of all domain |
| | names for the user's website or application. |
| STEP 2. | For each domain name the heuristic strips out |
| | the subdomain prefixes for example .com, .co, |
| | .net and pushes this string in a pattern. |
| STEP 3. | The heuristic checks for the all traffic |
| | sources for the user's website or application |
| | and matches the pattern with the incoming |
| | traffic to generate a list of self-referrals |
| | for the user in the audit report. The heuristic |
| | will generate instructions on how to add |
| | domains to the referral exclusion list, how to |
| | set auto cookie domains in the Google Analytics |
| | Tracking code ™ (GATC) and how to modify the GATC. |

### Example 16

FIG. 17 describes the assessment of traffic sources in the user's website or application. The steps involved are:

| | |
|---|---|
| STEP 1. | The heuristic checks what the top 3 traffic |
| | sources or top 3 goal conversions are on the |
| | user's website or application. For this the |
| | heuristic examines whether traffic source or |
| | traffic medium is equal to direct or none. The |
| | top 3 traffic sources or top 3 goal conversions |
| | will be updated in the audit report for review. |
| | The heuristic generates instructions for the |
| | user to ensure that GATC is on for all pages |
| | and that cross-domain tracking is configured. |
| STEP 2. | The heuristic checks whether self-referral |
| | traffic makes up the top 3 traffic sources or |
| | goal conversions. For this the heuristic looks |
| | at traffic where source or medium is from one |
| | of the user's own domains and whether this |
| | forms the top 3 traffics sources or top 3 goal |
| | conversions. The heuristic updates the audit |
| | report and generates instructions to the user |
| | to ensure that GATC is on for all pages and |
| | that cross-domain tracking is configured. |
| STEP 3. | The heuristic checks whether there are sources |
| | that have an unusually high bounce rate. For |
| | this the heuristic looks at bounce rate for each |
| | traffic source and highlights any portion of |
| | the website or application where the bounce rate |
| | is greater than 90% in the audit report. |
| STEP 4. | The heuristic checks whether the UTM campaign |
| | parameters are correctly retained or dropped when |
| | the user lands on the homepage or either one of |
| | top 5 landing pages. For this the heuristic |
| | crawls the top 5 landing pages and appends the |
| | test UTM parameters. If the homepage redirects, |
| | the heuristic checks that the UTM parameters and |
| | values are retained in the redirect. The heuristic |
| | updates the audit report for UTM campaign |
| | parameters and generates instructions to the user |
| | as to how they can configure their redirects so |
| | that UTM parameters and values are retained upon |
| | redirection. |
| STEP 5. | The heuristic checks whether brand and generic |
| | channel grouping have been setup in the user's |
| | analytic setup and checks for the enablement of |
| | these settings. The heuristic will update the |
| | audit report and generates instruction on how to |
| | set up. |

### Example 17

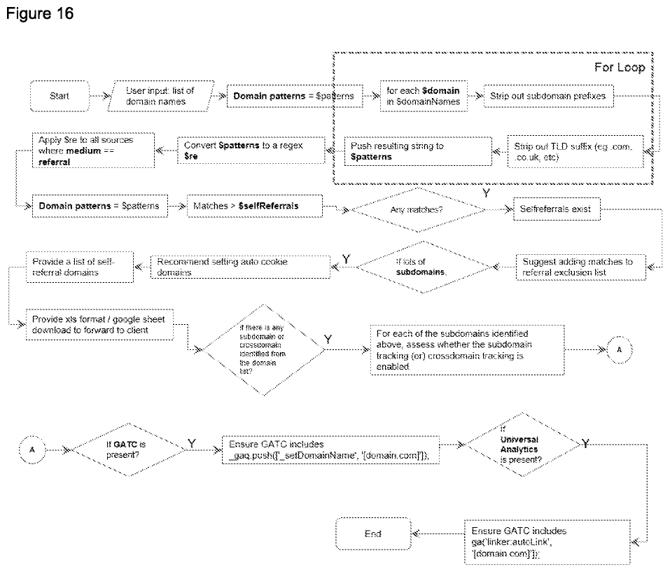

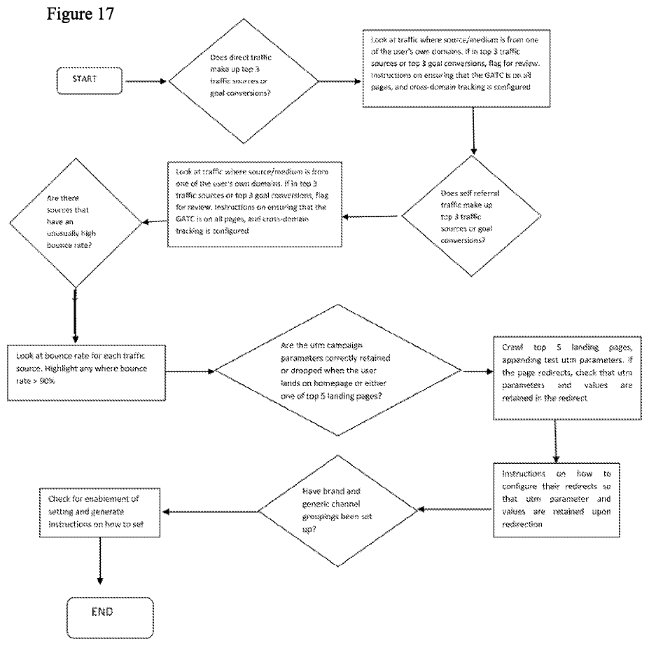

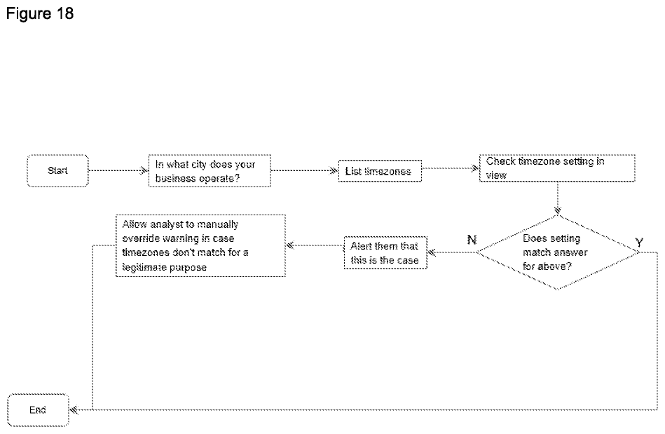

FIG. 18 describes the assessment of the time zone for the user's website or application. The time zone setting should align with the time zone in which the business primarily operates in.

The time zone affects what constitues a “day”, report scheduling, hour of day reports, and Session handling. The steps involved are:

| | |
|---|---|
| STEP 1. | The heuristic checks the place of business and |
| | the time zone setting for the user's website or |
| | application and generates a warning if the setting |
| | does not match the place of business. |

### Example 18

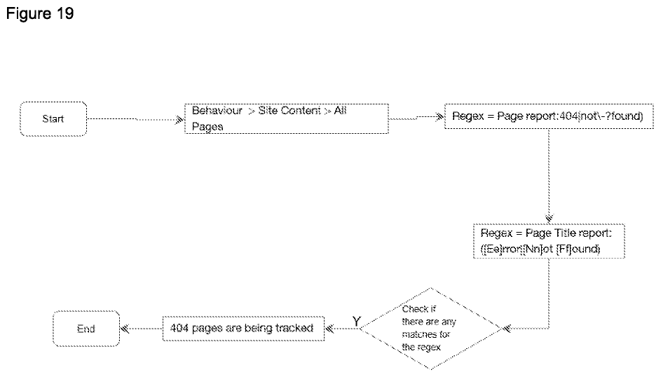

FIG. 19 describes tracking 404 pages in the user's website or application. The steps involved are:

| | |
|---|---|
| STEP 1. | The heuristic crawls 404 URLs and look for presence |
| | of GA or GTM tags on those pages (GTM: Google Tag |
| | Manager). |
| STEP 2. | The heuristic will update the list of “404 pages” |
| | in the Audit Report and generates instructions on |
| | how to track 404 pages. |

### Example 19

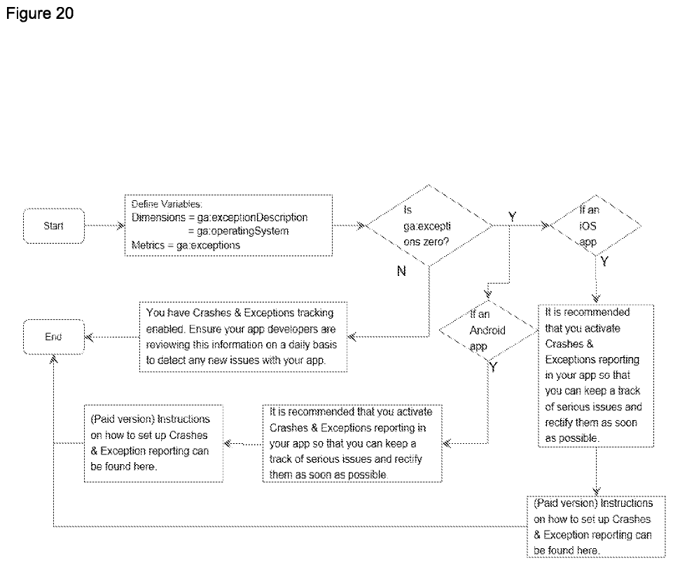

FIG. 20 describes the checking of the Crashes and Exception Process flow. The present invention works for the user's applications running on different operating systems such as Android, Windows Operating System, iPhone Operating System (iOS™). The steps involved are:

| | |
|---|---|
| STEP 1. | The heuristic checks whether the crash and |
| | exception reporting is activated in the user's |
| | application. For this the heuristic extracts the |
| | information regarding the operating system on |
| | which the user's application is running, a list |
| | of exceptions recorded and the description of the |
| | recorded exceptions |
| STEP 2. | If the recorded exception is equal to zero, the |
| | heuristic checks for the type of operating system |
| | and generates instructions for the user for the |
| | crashes and exceptions process flow. The generated |
| | instruction is: “It is recommended that you activate |
| | Crashes and Exceptions reporting in your |
| | application so that you can keep track of serious |
| | issues and rectify them as soon as possible”. The |
| | present invention will generate the implementation |
| | guide link describing the steps to follow for |
| | setting up the Crashes and Exception in the GA. |
| STEP 3. | If the recorded exception is not zero, the heuristic |
| | will update the Audit report with this message “You |
| | have Crashes and Exceptions tracking enabled. Ensure |
| | your application developers are reviewing this |
| | information on a daily basis to detect any new |
| | issues with your application.” |

### Example 20

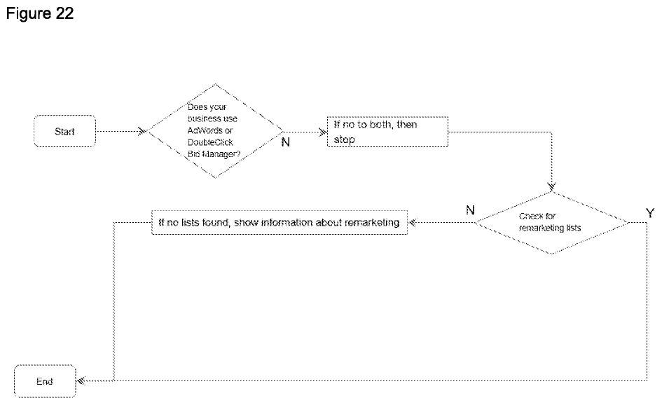

FIG. 22 describes the checking of Remarketing lists process flow. The steps involved are:

| | |
|---|---|
| STEP 1. | The heuristic checks whether the user's website or |
| | application uses Google AdWords, DoubleClick |
| | Campaign Manager, DoubleClick Search or DoubleClick |
| | Bid Manager ™ |
| STEP 2. | If the user's website or application uses one of |
| | them then the heuristic checks for the GA |
| | remarketing lists and updates the Audit report |
| | with the GA remarketing list. |
| STEP 3. | If the heuristic finds no GA remarketing lists |
| | then it updates the Audit Report and instructions |
| | on how to set up GA remarketing list. |

### Example 21

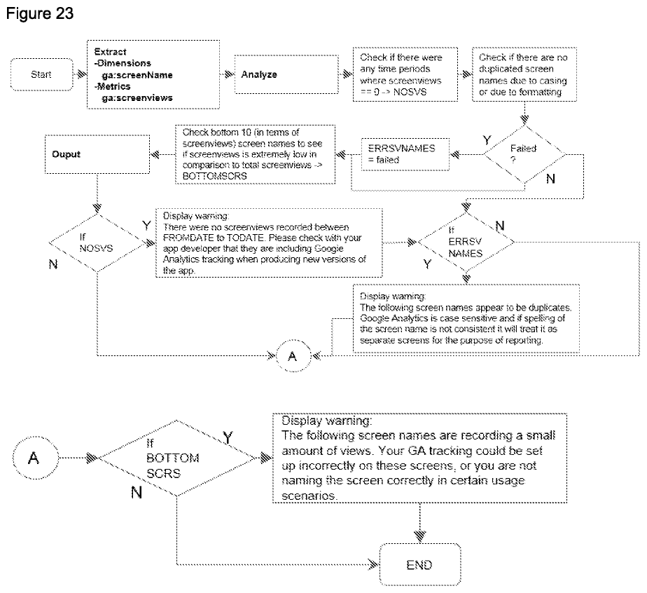

FIG. 23 describes the checking of Screen Names. The steps involved are:

| | |
|---|---|
| STEP 1. | The heuristic extracts a list of screen names and |
| | screen views from the analytics data. |
| STEP 2. | The heuristic checks for the time period when the |
| | number of screen views were equal to zero. |
| STEP 3. | The heuristic checks for the duplicate screen |
| | names due to casing or formatting. |
| STEP 4. | If there are duplicate screen names in the list |
| | the Audit report will be updated with the list |
| | of duplicate names and a warning is generated in |
| | the Audit Report informing the user that “The |
| | following screen names appear to be duplicates |
| | and GA is case sensitive and if the spelling of |
| | the screen name is not consistent it will treat |
| | it as separate screens for the purpose of |
| | reporting.” |
| STEP 5. | If there are no duplicate screen names detected |
| | by the heuristic, the heuristic will list the |
| | bottom 10 screen names (in terms of screen views) |
| | to check if this number of screen views is |
| | extremely low in comparison to total number of |
| | screen views and will update the Audit report |
| | with this list. |
| STEP 6. | If the number of screen views are equal to zero |
| | then the heuristic will generate a warning in |
| | the Audit report informing the user that “There |
| | were no screen views recorded between FROM_DATE |
| | to TO_DATE. Please check with your application |
| | developer that they are including GA tracking |
| | when producing new versions of the application”. |

### Example 22

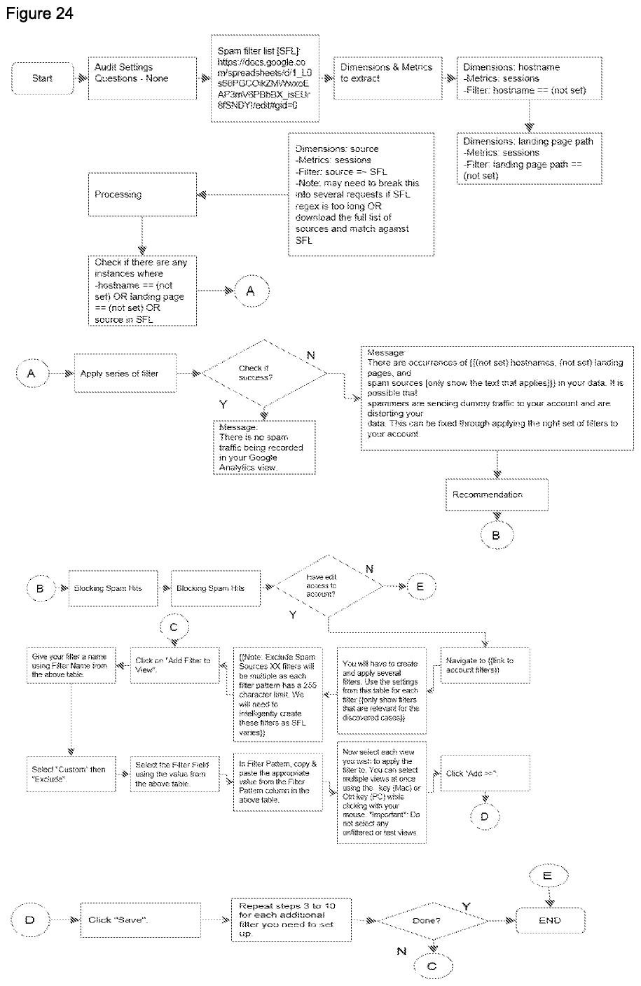

FIG. 24 describes the checking of the Spam Traffic in the user's website or application. The steps involved are:

| | |
|---|---|
| STEP 1. | The heuristic checks for a significant volume of |
| | hits from unidentified (i.e. not set) hostnames |
| | and generates instructions on how to create a |
| | filter to exclude hits with (not set) hostnames. |
| STEP 2. | The heuristic checks for a significant volume of |
| | hits for landing pages where URL is not set and |
| | generates instructions on how to create a filter |
| | to exclude hits with (not set) landing pages. |
| STEP 3. | The heuristic extracts a source data from the |
| | user's website or application via API and the |
| | source data against pre-defined spam sources list |
| | and generates instructions to create filters to |
| | filter out hits from the spam sources. |

### Example 23

The assessment of the AdSense Linkage in the user's website or application.

| | |
|---|---|
| STEP 1. | The heuristic checks if the user's website or |
| | application uses AdSense and whether the user |
| | has linked their AdSense account to GA. |
| STEP 2. | If the user indicates that they use AdSense, |
| | the heuristic checks for the presence of non- |
| | zero data in the AdSense Page Impressions |
| | dimensions via respective GA API or AA API. |
| STEP 3. | If non-zero data is present in the AdSense |
| | Page Impressions dimension then the heuristic |
| | generates instructions as to how the AdSense |
| | account can be linked to the analytic setup of |
| | the user's website or application. |

### Example 24

The assessment of an Attribution model in the user's analytic setup.

| | |
|---|---|
| STEP 1. | The heuristic checks if the user is a GA Premium |
| | user and whether the user has enabled data driven |
| | models. |
| STEP 2. | The heuristic will update the audit report on the |
| | attribution model and generates instructions on |
| | how to enable data driven models. |

### Example 25

The assessment of a DoubleClick Bid Manager™ (DBM) Integration in user's analytic setup.

| | |
|---|---|
| STEP 1. | The heuristic checks if DBM is integrated with |
| | the user's analytic setup and looks for non-zero |
| | data in DBM related dimensions via GA API. |
| STEP 2. | The heuristic will update the audit report on |
| | the DBM integration and generates instructions |
| | on how the user's DBM account can be linked to GA. |

### Example 26

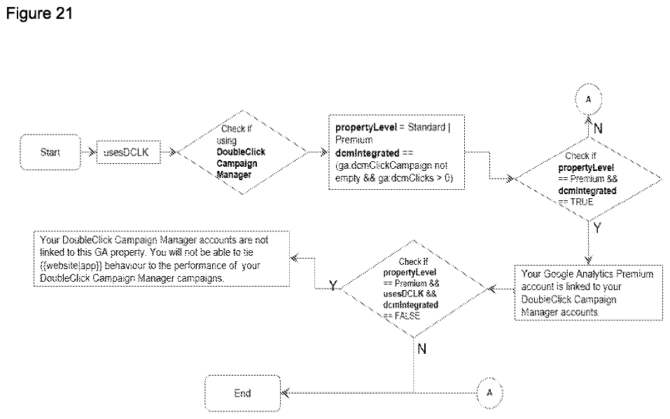

FIG. 21 describes the assessment of DoubleClick Campaign Manager™ Integration (DCM) in user's analytic setup. The steps involved are:

| | |
|---|---|
| STEP 1. | The heuristic checks whether the user is using |
| | “DoubleClick Campaign Manager”. |
| STEP 2. | If the user's property level is “Premium” and |
| | “DoubleClick Campaign ™” and the report is “not |
| | empty”, The heuristic will update the Audit report |
| | informing the user that “Your GA Premium account |
| | is linked to your DoubleClick Campaign Manager ™ |
| | account.” |
| STEP 3. | If the user's property level is “Premium” and |
| | “DoubleClick Campaign ™” and the report is |
| | “empty”, the heuristic will update the Audit report |
| | informing the user that “Your DoubleClick Campaign |
| | Manager ™ account is not linked to this GA property. |
| | You will not be able to tie you website/application |
| | behavior to the performance of your DoubleClick |
| | Campaign Manager ™ campaigns.” |

### Example 27

The assessment of a DoubleClick Search™ (DS) Integration in user's analytic setup.

| | |
|---|---|
| STEP 1. | The heuristic checks if DS is integrated with the user's |
| | analytic setup and looks for non-zero data in DS- |
| | related dimensions via GA API. |
| STEP 2. | The heuristic will update the audit report on the DS |
| | integration and generates instructions as to how the |
| | user's their DS account may be linked to GA. |

### Example 28

The assessment of Google Ad Exchange™ Linking in user's analytic setup.

| | |
|---|---|
| STEP 1. | The heuristic checks if the user has linked Google |
| | Ad Exchange ™ account to GA, and checks for the |
| | enablement of setting. |
| STEP 2. | The heuristic updates the audit report on the |
| | Google Ad Exchange ™ Linking and generates |
| | instructions on how to link Google Ad Exchange ™ |
| | account. |

### Example 29

The assessment of Google Analytics Tracking Code™ (GATC) in user's analytic setup.

| | |
|---|---|
| STEP 1. | The heuristic checks whether the latest GATC version |
| | is in use and crawls to the user's homepage and |
| | identifies GATC and its version used on the user's |
| | website or application. |
| STEP 2. | The heuristic will update the audit report on GATC |
| | and generates a recommendation to upgrade to the |
| | latest version of GATC. |
| STEP 3. | The heuristic checks whether GATC in the recommended |
| | position on the user's homepage of website or application. |
| | For this the heuristic crawls to the user's homepage |
| | and determine whether GATC is in the <head> block of |
| | the homepage's HTML code. The heuristic will update |
| | the audit report and generate a recommendation as |
| | to where to move GATC in the homepage's HTML code. |
| STEP 4. | The heuristic checks whether there are multiple GATCs |
| | on the user's homepage. For this, the heuristic crawls |
| | to the user's homepage and determine if there are |
| | multiple GATCs on the homepage. It will update the |
| | audit report and generate a recommendation to remove |
| | duplicate or redundant GATCs. |

### Example 30

The assessment of Google BigQuery™ Linking in user's analytic setup.

| | |
|---|---|
| STEP 1. | The heuristic checks if the user has a GA Premium |
| | account and has the user linked it with GoogleBigQuery ™ |
| | and also checks for the enablement of setting. |
| STEP 2. | The heuristic will update the audit report for Google |
| | BigQuery ™ Linking and generates instructions as to |
| | how the user's analytic account may be linked to |
| | Google BigQuery ™ |

### Example 31

The assessment of Page URL consistency in user's analytic setup.

| | |
|---|---|
| STEP 1. | The heuristic checks whether page paths are recorded |
| | consistently without mixing of cases. For this the |
| | heuristic extracts Page Path data via GA API and |
| | process to check for consistency in casing. |
| STEP 2. | The heuristic will update the audit report for Page |
| | URL consistency and generates instructions for |
| | applying a lowercase filter to change all page URLs |
| | recorded in GA to the lowercase. |

### Example 32

The assessment of default URL in the Property Settings in user's analytic setup.

| | |
|---|---|
| STEP 1. | The heuristic checks if the correct default URL |
| | setting is correct and compares top hostname value |
| | with default URL setting. These should match. |
| STEP 2. | The heuristic will update the audit report for |
| | Property Settings and generate instructions on how |
| | to set a correct default URL. |

### Example 33

The assessment of Property Type in user's analytic setup.

| | |
|---|---|
| STEP 1. | The heuristic checks whether the type of property |
| | chosen for the website or application is |
| | appropriate and checks the Data Source Dimension |
| | to see where majority of hits come from on the |
| | user's website or application. The heuristic also |
| | checks whether Data Source aligns with the |
| | Property Type of the user's website or application. |
| STEP 2. | The heuristic will update the audit report for the |
| | Property type and generate instructions on how to |
| | set up tracking with the correct property type. |

### Example 34

The assessment of Site Search tracking in user's analytic setup.

| | |
|---|---|
| STEP 1. | The heuristic checks if personally identifiable |
| | information is being recorded. The heuristic extracts |
| | data via API and searches for PII patterns (such as |
| | email addresses). The heuristic provides guidance on |
| | stopping the recording of PII and/or applying filters |
| | to obfuscate PII. |
| STEP 2. | The heuristic checks whether website search tracking |
| | is enabled in the user's analytic setup and if user's |
| | website or application offers searching functionality. |
| | The heuristic will update the audit report for the |
| | Site Search Tracking and generate instructions on how |
| | to enable the Site Search Setting in user's analytic |
| | setup. |
| STEP 3. | The heuristic checks whether the query parameter is |
| | non empty. The heuristic will update the audit report |
| | for the Site Search Tracking and generate instructions |
| | on how to enable the Site Search Setting in user's |
| | analytic setup. |
| STEP 4. | The heuristic checks whether, if the query parameter |
| | is non empty, the strip query parameters setting is |
| | ticked. The heuristic will update the audit report |
| | for the Site Search Tracking and generate instructions |
| | on how to enable the Site Search Setting in user's |
| | analytic setup. |
| STEP 5. | The heuristic checks whether conversions are being |
| | attributed to search terms and determines if |
| | conversion rate or conversion value per search term |
| | is >0. The heuristic generates instructions on how |
| | to implement cross-domain tracking. |

### Example 35

The assessment of Within Hit Limits in user's analytic setup.

| | |
|---|---|
| STEP 1. | The heuristic checks whether the user's account is a |
| | non-premium account and close to exceeding 10M hits |
| | per month. For this the heuristic counts the total |
| | number of hits for the last 30 days. If the number |
| | of hits is greater than 8.5 million, the heuristic |
| | flags it for review. |
| STEP 2. | The heuristic will update the audit report for the |
| | Within Hit Limits and generate a recommendation for |
| | user to upgrade to GA360. |

1. An automated method for assessing a website or an application, comprising the steps of:
(a) obtaining function data relating to the functions and options selected by a user of the website or application;
(b) accessing analytics data relating to the website or application;
(c) accessing the website data or application data including HTML data;
(d) analyzing the analytics data, website data and function data, using a set of heuristics assessing predetermined analysis points in order to audit the operation of the website or application and determine the performance of the website or application in relation to predetermined parameters relating to each analysis point, wherein the number of analysis points is at least 30; and
(e) providing an audit score and report, derived from the outcome of said heuristics, including a prioritized categorization of the identified issues requiring rectification.

2. The method according to claim 1, wherein the method further includes providing, in response to the identified issues, an automatically generated, implementation-instruction guide which provides solutions for the issues identified, the guide being customized in response to the issues identified, based on the assessment of the analytics data, web site data and function data for each analysis point, the implementation-instruction guide enabling the user to implement the solutions and rectify their website or application without requiring a consultant.

3. The method according to claim 1, wherein the number of analysis points is at least 25.

4. A The method according to claim 1, wherein the number of analysis points is at least 35.

5. The method according to claim 2, wherein the number of analysis points is at least 25.

6. The method according to claim 2, wherein the number of analysis points is at least 35.
